(19) United States
(12) Patent Application Publication
(10) Pub. No.: US 2005/0220596 A1
(43) Pub. Date: Oct. 6, 2005

(54) Method and apparatus for hydraulically produced ground following of an unloading ramp for a cotton harvester

(75) Inventors: Steven E. Gaedy, Bettendorf, IA (US); Michael J. Covington, Bettendorf, IA (US)

Correspondence Address: CNH AMERICA LLC, INTELLECTUAL PROPERTY LAW DEPARTMENT, 700 STATE STREET, RACINE, WI, 53404, US

(73) Assignee: CNH America LLC

(21) Appl. No.: 11/089,237

(22) Filed: Mar. 24, 2005

Related U.S. Application Data
(60) Provisional application No. 60/558,275, filed on Mar. 30, 2004.

(51) Int. Cl. B60P 1/43

(52) U.S. Cl. 414/537

(57) ABSTRACT

Apparatus and method providing a ground following capability for an unloading ramp on a receiver of a cotton harvester. At least one fluid cylinder is provided including at least one rod extendible for moving the ramp downwardly to an unloading position and retractable for raising the ramp. A valve apparatus is connected between a source of pressurized fluid and the at least one cylinder and is controllably operable by a control for directing pressurized fluid to the at least one cylinder for extending the at least one rod for moving the ramp to the unloading position. The valve apparatus is automatically operable responsive to exertion of a force against at least one of the rods in a direction for retracting the rod, for directing pressurized fluid from the at least one cylinder to allow the rod to be retracted by the force to thereby raise the ramp.

This application claims the benefit of U.S. Provisional Application No. 60/558,275, filed Mar. 30, 2004.

### TECHNICAL FIELD

This invention relates generally to apparatus and a method providing a ground following feature for an unloading ramp for a cotton harvester, and more particularly, to apparatus and a method which provides the ground following feature while still providing a holding capability for uncommanded movement.

### BACKGROUND ART

It is a desirable feature of a cotton harvesting machine to have a ramp which can be extended at an incline from a cotton receiver or holding apparatus on the harvesting machine, such as a basket, packager or module builder, to the ground or another surface onto which the harvested cotton is to be unloaded. Such an unloading ramp preferably has one or more sections pivotable or foldable between an upstanding closed position in covering relation to the open end of the cotton receiver, and an open position extending from the open end of the receiver to the ground or other surface onto which the cotton is to be unloaded. Movement of the ramp between the closed and open positions is typically accomplished using one or more fluid cylinders which are typically extended to move the ramp to the open position. The end of the ramp opposite the cotton receiver is typically supported on the ground or other surface on a plurality of skids, rollers or wheels to facilitate movement thereof over the ground or other surface. A compacted body or module of cotton can weigh several thousand pounds. Therefore, to smoothly unload the compacted cotton onto the ground or other surface, the cotton harvesting machine and ramp are typically moved at a slow speed in a forward direction as the cotton makes the transition onto the ground. This presents a problem when the end of the ramp and/or the machine must pass over obstacles and/or irregularities on the ground, such as a rock, bump, or the like, as any upward movement of the end of the ramp, particularly when supporting several thousand pounds of cotton, can cause damage to the ramp and/or the fluid cylinder or cylinders.

Accordingly, what is sought is a method and apparatus for providing a ground following capability for an unloading ramp for a cotton harvester which overcomes one or more of the problems set forth above.

### SUMMARY OF THE INVENTION

According to a preferred aspect of the invention, apparatus and a method for providing a hydraulically produced ground following capability of an unloading ramp for a cotton harvesting machine which overcomes one or more of the problems set forth above, is disclosed. The apparatus and method are adapted for use with one or more double acting fluid or hydraulic cylinders operable for pivotally moving the unloading ramp between a closed position in covering relation to an open end of a cotton receiving basket, compacting chamber, packager or module builder of the cotton harvesting machine, and an open position oriented at an incline extending downwardly from the open end to the ground or another surface onto which the cotton from the receiver is to be unloaded. With the ramp in the open position, as the cotton is being unloaded and the machine is moving forward, with one or more skids, rollers or wheels supporting a free end of the ramp on the ground or other surface, and moving over varying contours, obstacles and/or imperfections in the surface, the present invention will allow the one or more cylinders to retract and extend as required, such that damage to the cylinder or cylinders and/or the ramp is avoided.

### BRIEF DESCRIPTION OF THE DRAWINGS

FIG. 1 is a simplified side view of a representative cotton harvesting machine including a cotton receiver shown tilted to an inclined unloading position and an unloading ramp thereof in an open position;

FIG. 2 is a simplified fragmentary side view of the machine of FIG. 1, showing unloading of a compacted body of cotton onto the ground;

FIG. 3 is another fragmentary side view of the machine of FIG. 1, showing the unloading of the cotton onto the ground as the unloading ramp passes over a rock;

FIG. 4 is another fragmentary side view of the machine showing a rear wheel thereof passing over a depression in the ground;

FIG. 5 is another simplified side view of the machine showing a front wheel thereof passing over a bump on the ground;

FIG. 6 is a schematic representation of apparatus according to the invention;

FIG. 7 is another schematic representation of the apparatus of the invention; and

FIG. 8 is still another schematic representation of the apparatus of the invention.

### DETAILED DESCRIPTION OF THE INVENTION

Referring now to the drawings, in FIG. 1, a representative cotton harvesting machine 10 is shown including an unloading ramp 12 shown pivoted to an unloading or open position extending rearwardly from an open end 14 of a cotton receiver 16 of machine 10, downwardly to a ground surface 18. Cotton receiver 16 is representative of a wide variety of receivers such as a basket, a cotton compactor, a packager, or a module builder, and is shown supported at an unloading incline by a fluid cylinder 20. Unloading ramp 12 in its unloading position forms a substantially planar continuation of a floor 22 of receiver 16. Ramp 12 is preferably pivotally connected to receiver 16 by a pivotal connection 42, and is pivoted and unfolded to the open unloading position shown and is held in that position by four fluid cylinders, including a pair of first cylinders 24 connected between cotton receiver 16 and a first ramp segment 26, and a pair of second cylinders 28 in a slave relationship to first cylinders 24 and connected between first ramp segment 26 and a second ramp segment 30. First and second cylinders 24 and 28 are operable in concert for pivoting and holding first and second ramp segments 26 and 30 in overlaying or covering relation to open end 14 of cotton receiver 16.

When unloading ramp 12 is in the fully open position as shown, rods 32 of first cylinders 24 will extend therefrom a distance A, and rods 34 of second cylinders 28 will extend a distance B therefrom. The end of second ramp segment 30 is supported on ground surface 18 for movement therealong by wheels 36. Here, it should be noted that it is desirable for cylinders 24 and 28 to have the capability for holding ramp 12 substantially fixedly or rigidly in the unloading position as shown, to allow passage of a compacted body of cotton thereover between cotton receiver 16 and ground surface 18 without significant sagging or buckling. It is also desirable for cylinders 24 and 28 to have the capability to allow ramp 12 to have a ground following capability so as to pivot relative to cotton receiver 16 sufficiently to pass over obstacles such as bumps, rocks, logs, depressions, small ditches, and the like, without placing potentially damaging loads and stresses on the cylinders and ramp 12, as machine 10 is moved over the ground in the forward direction during the unloading operation.

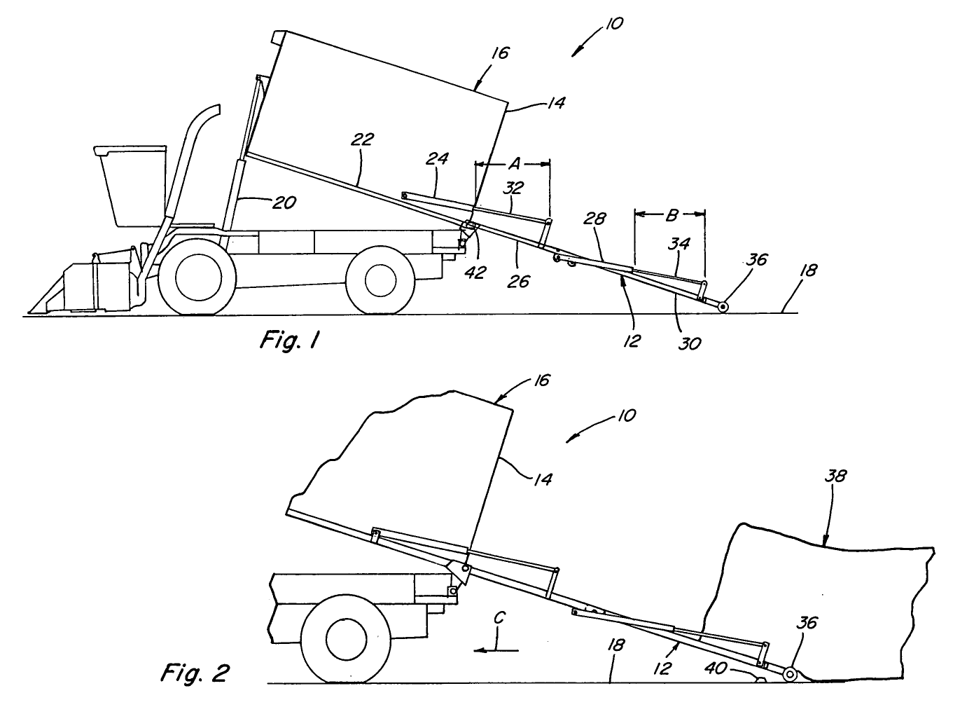

Referring also to FIG. 2, cotton harvesting machine 10 is again shown with unloading ramp 12 in its unloading or open position relative to open end 14 of cotton receiver 16, which is tilted in its unloading position. A compacted body of cotton 38 is shown being unloaded from ramp 12 onto ground 18 as machine is moved in the forward direction, as denoted by arrow C. Wheel 36 is shown approaching a rock 40 on ground surface 18.

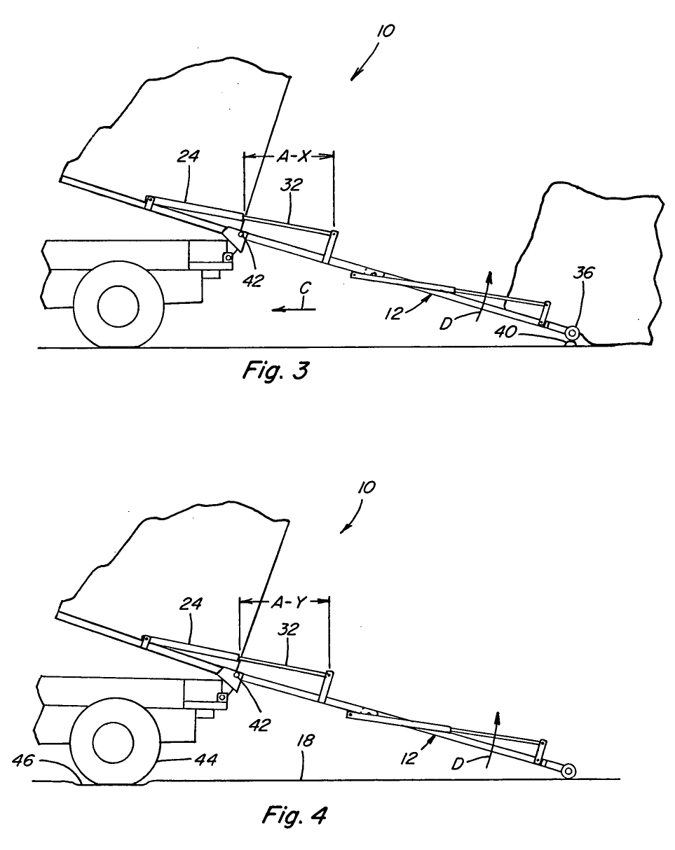

Referring also to FIG. 3, machine 10 is moved such that wheel 36 of unloading ramp 12 is shown atop rock 40, and ramp 12 is shown pivoted in the direction D about pivotal connection 42 relative to cotton receiver 16 as machine 10 continues to move in direction C during the unloading. As will be explained, the movement of ramp 12 in direction D about pivot 42 is allowed by automatic retraction of rod 32 into cylinder 24 by an amount X, as denoted by the distance A-X as a result of the ground following capability according to the invention.

Referring also to FIG. 4, a rear wheel 44 of machine 10 is shown in a depression 46 in ground surface 18, and to reduce harmful loads and stresses on ramp 12, ramp 12 is again allowed to pivot as denoted by arrow D about connection 42 by the retraction of rod 32 into cylinder 24 by an amount Y, as shown by distance A-Y, as allowed by the apparatus of the present invention.

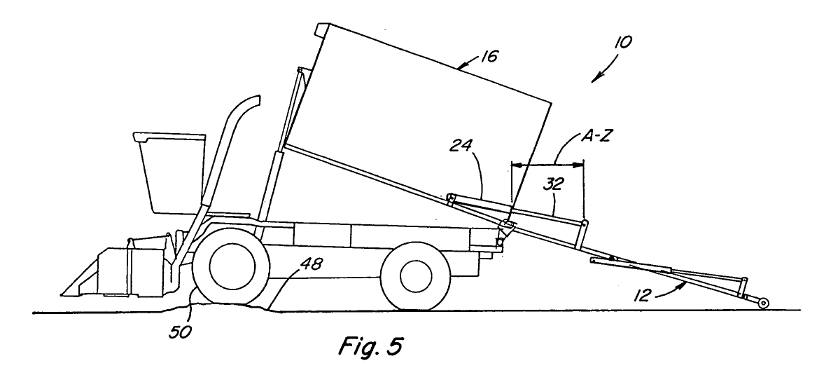

FIG. 5 shows retraction of rod 32 into cylinder 24 by the amount Z, as shown by distance A-Z to allow pivotal movement of ramp 12 relative to receiver 16 as a front wheel 50 moves over a mound 48, again as allowed by apparatus of the present invention.

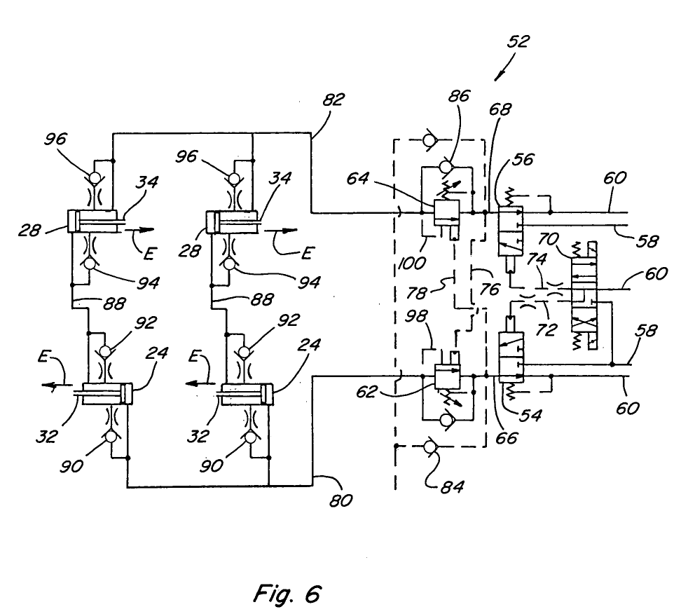

Also referring to FIG. 6, apparatus 52 for controlling extension and retraction of rods 32 of first cylinders 24 and rods 34 of second cylinders 28 for pivotally moving ramp 12 between its closed and open unloading positions, is shown. Apparatus 52 is also operable according to the present invention for providing an automatic ground following capability for relative pivotal movement of machine 10 and ramp 12 about pivotal connection 42 for movement over obstacles and irregularities such as rock 40, depression 46 and mound 48, without undesirably loading and stressing ramp 12 and the components thereof, including cylinders 24 and 28. Apparatus 52 includes a pair of directional control valves 54 and 56 which are preferably three-way valves, such as commercial available spool valves or the like, each having a port connected by a fluid line 58 to a source of pressurized fluid such as a conventional fluid pump (not shown) on machine 10 in the well known manner. Valves 54 and 56 also include a port connected by a fluid line 60 to a tank or reservoir (also not shown) on machine 10 in the conventional manner. The third ports of valves 54 and 56 are connected to ports of counterbalance valves 62 and 64, by fluid lines 66 and 68, respectively. Directional control valves 54 and 56 are controlled by a pilot control valve 70 connected to respective valves 54 and 56 by pilot control lines 72 and 74. Pilot control valve 70, in turn, is operator controllable for selectably delivering pressurized fluid through pilot control lines 72 and 74 to valves 54 and 56, respectively, for delivering pressurized fluid through counterbalance valves 62 and 64 to cylinders 24 and 28, for effecting pivotal movement of ramp 12, as will be discussed hereinbelow.

Counterbalance valves 62 and 64 are preferably each a two-way pilot controlled pressure relief valve having pilot signal ports connected to fluid lines 68 and 66, respectively, by pilot control lines 76 and 78. The second port of counterbalance valve 62 is connected by a fluid line 80 to head end ports of cylinders 24. The second port of counterbalance valve 64 is connected by a fluid line 82 to rod end ports of cylinders 28. A check valve 84 is connected between lines 66 and 80 to allow fluid flow around counterbalance valve 62 in the direction toward cylinders 24. Similarly, a check valve 86 connects lines 68 and 82 to allow fluid flow around valve 64 to cylinders 28. Rod end ports of cylinders 24 are connected by lines 88 to head end ports of cylinders 28. Check valves 90 are disposed between line 80 and an intermediate port of cylinders 24, to allow fluid flow from the cylinders. Check valves 92 are disposed between lines 88 and additional intermediate ports of cylinders 24 to allow flow from the cylinders. Check valves 94 are disposed between lines 88 and intermediate ports on cylinders 28 to allow flow from the cylinders, and additional check valves 96 connect lines 82 and intermediate ports on cylinders 28 to allow flow from the cylinders.

In operation, to move ramp 12 to its unloading or open position, pilot control valve 70 is moved by the operator to its upper position to allow pressurized fluid flow from line 58 through line 72 to directional control valve 54 to move that valve to its upper position. In this mode, pilot control valve 70 connects line 74 to tank via line 60, such that valve 56 remains in the position shown. Pressurized fluid will then flow from line 58 through valve 54 to line 66, and through check valve 84 to line 80, to the head end ports of cylinders 24. Initially, until sufficient pressure is developed, rods 32 will not be moved, as fluid cannot pass through counterbalance valve 64, which is closed. However, pressure buildup in line 66 will be communicated to valve 64 via line 78 to move that valve to its open position when its pilot pressure is reached. This will allow fluid flow through valve 64 from line 82 to line 68. Pressurized fluid can now flow through the head end ports of cylinders 24 to extend rods 32, as denoted by arrow E, and the fluid from the rod ends of those cylinders will flow through lines 88 into the head end ports of cylinders 28, to extend rods 34, as denoted by arrow E, thereof such that unloading ramp 12 will be fully opened in its unloading position.

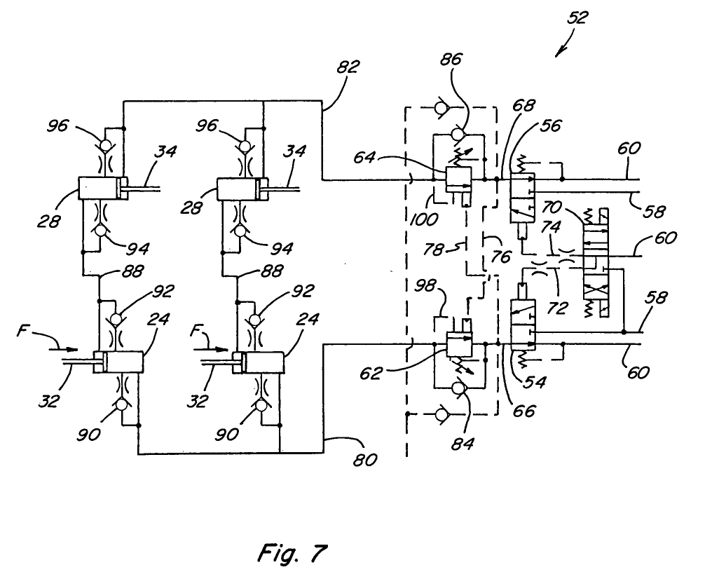

Referring also to FIG. 7, apparatus 52 is shown with rods 32 and 34 of fluid cylinders 24 and 28, respectively, extended by the distances A and B shown in the previous figures, such that ramp 12 is in its open unloading position. With cylinders 24 and 28 extended in this manner, the ground following capability according to the present invention, for reducing loading and stress on the cylinders and also on ramp 12, will be explained. Essentially, when any of the conditions illustrated in FIGS. 3, 4 and 5 are encountered, a force will be applied against rods 32, as denoted by arrows F to urge the rods to retract. Referring briefly back to FIG. 1, second ramp segment 40 is pivotable to the position shown in a counterclockwise direction, and hard stops prevent further pivotal movement in that direction. The application of forces F on rods 32 will serve to increase pressure of fluid in the head ends of cylinders 24, which pressure will be transferred through lines 80 and 98 to valve 62. The pressure will also be transferred through check valves 92 and lines 88 to the head ends of cylinders 28, and through check valves 96 and lines 82 and 100 to valve 64. When the pressure exceeds the pilot pressure of valve 62, that valve will open to allow fluid flow through line 66 to valve 54 and through that valve and line 60 to tank. This will allow retraction of rods 32 by an appropriate or required distance X, Y or Z, and as rods 32 are displaced in the retracting direction, a vacuum condition is created in the rod ends of cylinders 24 causing check valves 92 to open such that fluid will be transferred from the head ends to the rod ends of those cylinders. The pressure condition in the head ends of cylinders 28 and line 82 will also be reduced. Once the affected wheel or wheels 36, 44 and/or 50 has passed the obstacle or depression, rods 32 will still be in the retracted position and wheels 36 will be elevated above the ground, thereby placing the weight of ramp 12 and any cotton thereon on the cylinders to urge them in the direction to extend, opposite the direction F. This will increase the pressure in the rod ends of the cylinders, particularly cylinders 24 which are not fully extended. This pressure will be transferred through lines 88 and the head ends of cylinders 28, check valves 96 and line 82 to pilot control line 100 of valve 64. When the pressure exceeds the pilot pressure of that valve, it will open to allow flow through line 68, valve 56 and line 60 to tank. As rods 32 again extend, a vacuum condition in the head ends of cylinders 24 will exist, which will be communicated through line 80 to check valve 84 which will open to allow oil flow into the head end of the cylinders. When the pressure condition is alleviated, valve 64 will close and the vacuum condition on check valve 84 will dissipate.

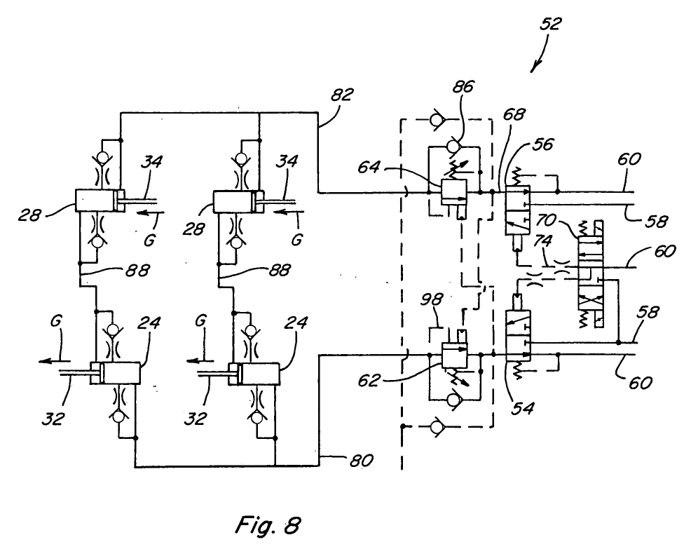

Referring also to FIG. 8, operation of apparatus 52 for retracting rods 32 and 34, as denoted by arrow G, of cylinders 24 and 28 for pivoting and folding ramp 12 to its closed position, will now be explained. In this operation, valve 70 is moved to its lower position to allow pressurized fluid from line 58 to pass through pilot control line 74 to valve 56 to move it to its lower position. Valve 54 will remain in the position shown. This will result in pressurized fluid moving through valve 56 and line 68 to check valve 86 and through that valve to line 82, bypassing valve 64. The pressurized fluid will then enter the rod ends of cylinders 28 and will build pressure. This pressure will be transferred through lines 88 to the rod ends of cylinders 24 to apply pressure against the fluid in the head ends thereof, which will increase pressure in lines 80 and 98 connected to valve 62. When the pressure in line 98 exceeds the pilot pressure of valve 62, that valve will open to allow escape of fluid from the head ends of cylinders 24. This will allow movement of fluid into the rod ends of those cylinders, such that rods 32 can retract and as that occurs, rods 34 will retract into cylinders 28, to thereby fold the ramp. Once the ramp is in its folded or closed position, valve 70 can then be returned to its neutral or middle position. With the ramp in this position, the cylinders are now held or locked in place because both pilot operated relief valves and both check valves associated therewith are closed thereby preventing fluid flow out of either end of the cylinders as long as cylinder pressure does not exceed the pressure relief pressures.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

1. Apparatus for positioning an unloading ramp of a cotton receiver of a self-propelled cotton harvesting machine in an unloading position extending at an incline downwardly from the receiver to a surface therebelow, comprising:
a fluid cylinder including a rod extendible for moving the ramp downwardly to the unloading position and retractable for raising the ramp therefrom; and
a valve apparatus connected between a source of pressurized fluid and the cylinder and controllably operable by a control for directing pressurized fluid to the cylinder for extending the rod for moving the ramp to the unloading position, wherein the valve apparatus is automatically operable responsive to exertion of a force against the rod in a direction for retracting the rod, for directing pressurized fluid from the cylinder to allow the rod to be retracted by the force to raise the ramp.

2. Apparatus of claim 1, wherein the valve apparatus is automatically operable for directing pressurized fluid to the cylinder for extending the rod after removal of the force.

3. Apparatus of claim 1, wherein the valve apparatus includes a first valve and a second valve, the first valve having a port in connection with the source of pressurized fluid and a port in connection with the fluid cylinder and being controllably operable for connecting the ports for allowing flow of the pressurized fluid to the fluid cylinder for extending the rod, the second valve including a port in connection with the fluid cylinder and a port in connection with another location, and being automatically operable by the exertion of the force against the rod to connect the ports thereof for allowing passage of fluid from the fluid cylinder for retracting the rod and raising the ramp responsive to the force.

4. Apparatus of claim 1, wherein after the rod has been retracted by the force, the unloading ramp will exert a force on the rod urging the rod to extent so as to create a partial vacuum condition in the cylinder acting to draw fluid therein, the valve apparatus being automatically operable to allow fluid flow to the cylinder responsive to the vacuum condition.

5. Apparatus of claim 4, wherein the valve apparatus includes a check valve disposed between the cylinder and a source of fluid and oriented to allow the fluid flow to the cylinder responsive to the vacuum condition.

6. Apparatus controllably operable for positioning an unloading ramp of a cotton receiver of a self-propelled cotton harvesting machine in an unloading position extending at an incline downwardly from the receiver to a surface therebelow, and automatically raising the unloading ramp responsive to contact with an obstacle on the surface as the ramp is moved therealong, comprising:
at least one fluid cylinder connected between the receiver and the ramp and including at least one rod extendible for positioning the ramp in the unloading position; and
valve apparatus connected between a source of pressurized fluid and the at least one cylinder and controllably operable for directing pressurized fluid to the at least one cylinders for extending the at least one rod thereof for moving the ramp to the unloading position, the valve apparatus being automatically operable responsive to a force exerted against at least one of the rods as a result of contact between the ramp and an obstacle on the surface for allowing the at least one rod to be retracted by the force to raise the ramp from the unloading position so as to pass over the obstacle, and the valve apparatus being further automatically operable responsive to removal of the force to allow fluid to flow to the at least one cylinder for returning the ramp to the unloading position.

7. Apparatus of claim 6, wherein the valve apparatus includes a first valve and a second valve, the first valve having a port in connection with the source of pressurized fluid and a port in connection with the at least one fluid cylinder and being controllably operable for connecting the ports for allowing flow of the pressurized fluid to the at least one fluid cylinder for extending the at least one rod thereof, the second valve including a port in connection with the at least one fluid cylinder and a port in connection with another location, and being automatically operable by the exertion of the force against the at least one rod to connect the ports thereof for allowing passage of fluid from the at least one fluid cylinder for retracting the at least one rod thereof and raising the ramp responsive to the force.

8. Apparatus of claim 6, wherein when the force is removed, a partial vacuum condition is created in the at least one fluid cylinder, and the valve apparatus including a check valve in connection with the at least one fluid cylinder and oriented to allow fluid flow to the at least one cylinder responsive to the partial vacuum condition for returning the ramp to the unloading position.

9. Apparatus of claim 6, wherein the valve apparatus includes a valve controllable by an operator for directing pressurized fluid to the at least one cylinder for extending the at least one rod thereof for moving the ramp to the unloading position.

10. A method of operation of a pivotable unloading ramp of a cotton receiver on a self-propelled cotton harvesting machine, comprising steps of:
providing at least one fluid cylinder connected between the receiver and a ramp and including at least one rod extendible for pivotably moving the ramp downwardly into an unloading position extending at a downward incline from the receiver to a surface therebelow; and
controllably operating the at least one fluid cylinder to extend the at least one rod to position the ramp in the unloading position; and moving the ramp over the surface, and if the ramp contacts an obstacle on the surface such that a force is exerted against the at least one rod urging retraction thereof into the cylinder, then automatically allowing retraction of the at least one rod by the force to raise the ramp to pass over the obstacle, and when the force is removed, automatically extending the at least one rod.

11. The method of claim 10, comprising the step of providing a valve apparatus connected between a source of pressurized fluid and the at least one cylinder and controllably operable for directing pressurized fluid to the at least one cylinder for extending the at least one rod thereof for pivotally moving the ramp to the unloading position, the valve apparatus being automatically operable responsive to the force exerted against the at least one rod for allowing the at least one rod to be retracted by the force, and the valve apparatus being further automatically operable responsive to removal of the force to allow fluid to flow to the at least one cylinder for extending the at least one rod.

12. The method of claim 11, wherein the valve apparatus includes a check valve disposed between the at least one cylinder and a source of fluid and oriented to allow fluid to flow to the cylinder for extension of the rod responsive to a partial vacuum condition in the at least one cylinder resulting from removal of the force.
